(19) United States
(12) Patent Application Publication
(10) Pub. No.: US 2010/0268653 A1
(43) Pub. Date: Oct. 21, 2010

(54) SYSTEM AND METHOD FOR FACILITATING RENTING AND PURCHASING RELATIONSHIPS

(76) Inventors: Scott S. Ingraham, Pacific Palisades, CA (US); Allan O. Hunter, Newport Beach, CA (US)

Correspondence Address: SCHWEGMAN, LUNDBERG & WOESSNER/EBAY, P.O. BOX 2938, MINNEAPOLIS, MN, 55402, US

(21) Appl. No.: 12/762,504

(22) Filed: Apr. 19, 2010

Related U.S. Application Data
(62) Division of application No. 09/802,719, filed on Mar. 8, 2001, now abandoned.
(60) Provisional application No. 60/188,099, filed on Mar. 9, 2000.

(51) Int. Cl. G06Q 50/00; G06Q 10/00

(52) U.S. Cl. 705/307; 705/313

(57) ABSTRACT

A system and method for facilitating renting and purchasing relationships. The method includes receiving at least one property profile from at least one responsible party. At least one transaction request from each of a plurality of responsible parties is received. The transaction requests are matched with the property profiles. The transaction requests are provided to the responsible parties of those properties that match the transaction request. In one embodiment, an offer received from at least one of the responsible parties is provided to at least one of the requesting parties. The method may be executed on a computer connected to a network such as the Internet.

### RELATED APPLICATIONS

This application is a divisional of U.S. application Ser. No. 09/802,719, filed Mar. 1, 2001, entitled “System and Method for Facilitating Renting and Purchasing Relationships” which claims the benefit of U.S. Provisional Application No. 60/188,099 filed Mar. 9, 2000, entitled “System and Method for Facilitating a Lessor-Rentor Relationship”, which are incorporated by reference in their entirety.

### FIELD OF THE INVENTION

The invention relates to the field of facilitating a business relationship between two parties. More specifically, the invention relates to a system and method for matching property owners and lessors with person(s) wanting to rent or acquire a certain type of property.

### BACKGROUND OF THE INVENTION

The process of locating a desirable apartment or other residential property may be daunting. Traditionally, renters and purchasers identify available properties by checking listings in newspapers or specialty publications. To determine whether a unit or a property is desirable, the potential renter and purchasers must visit a property and then view the advertised unit. Renters and purchasers often take marked-up newspapers and other publications and travel to view properties. In some instances, it may be a challenge to set up an agreeable time to view units or properties because of the inaccessibility of the unit or the unavailability of the property owner, leasing agent or property manager.

Renters and purchasers have now also begun using listing services available via Internet web sites to locate prospective rental units and properties. However, these listing services web site only ease the first step, that is, identifying available properties. The renter or purchaser must print out the most promising listings, must still visit listed properties, and must view the advertised unit or property. The difficulties in setting an appointment to view units or properties and communicating with the property owner, leasing agent or property manager are not ameliorated by using listing services web sites.

Sometimes renters and purchasers may use an apartment finding service, a house locator service, or a real estate agent for assistance. Although this kind of assistance is supposed to make the process easier, it may cost more money than many renters and purchasers want to spend, and may add a level of complexity to the process by having to coordinate with the agent or service.

### SUMMARY OF THE INVENTION

A system and method for facilitating renting and purchasing relationships. The method includes receiving at least one property profile from at least one responsible party. At least one transaction request from each of a plurality of responsible parties is received. The transaction requests are matched with the property profiles. The transaction requests are provided to the responsible parties of those properties that match the transaction request. In one embodiment, an offer received from at least one of the responsible parties is provided to at least one of the requesting parties. The method may be executed on a computer connected to a network such as the Internet.

### BRIEF DESCRIPTION OF THE DRAWINGS

FIG. 1 illustrates a general flow of actions of a transaction center system taken according to an embodiment of the system and method of the present invention.

FIG. 2 illustrates the network architecture of an embodiment of a system and method for facilitating renting and purchasing relationships over the Internet.

FIG. 3 illustrates a more detailed flow of actions of a transaction center server taken according to an embodiment of the system and method of the present invention.

FIGS. 4A-T illustrate various example web pages of an embodiment of a transaction center system according to an embodiment of the present invention.

### DETAILED DESCRIPTION OF THE INVENTION

In general, the present invention relates to a system and method for prospective renters or buyers to locate a suitable property available from lessors, property owners, etc.

In the following description, certain terminology is used to discuss features of the present invention. For example, the term “property owner” is intended to refer to any person, group of persons, or entity that is seeking rental or sale of a property in part or whole. Such a person or entity may be denoted a “responsible party” as it is this person, group of persons, or entity that is responsible for the renting or sale of the property. The property may include real property such as an apartment building, an apartment, a condominium building, a condominium unit, a cooperative building, a cooperative unit, a single family dwelling, a multi-family dwelling, a commercial building, and the like, and may also include personal property such as consumer merchandise and the like. The term “renter” is intended to refer to any person, group of people, business or any other entity that is interested in renting or perhaps purchasing an interest in the property. The interest may be 100% denoting a sale of the property in its entirety. According to the present invention, a renter or purchaser may be denoted a “requesting party” as it is the prospective renter's or purchaser's initial rental or purchase request that sets in motion events that may lead to a resulting transaction.

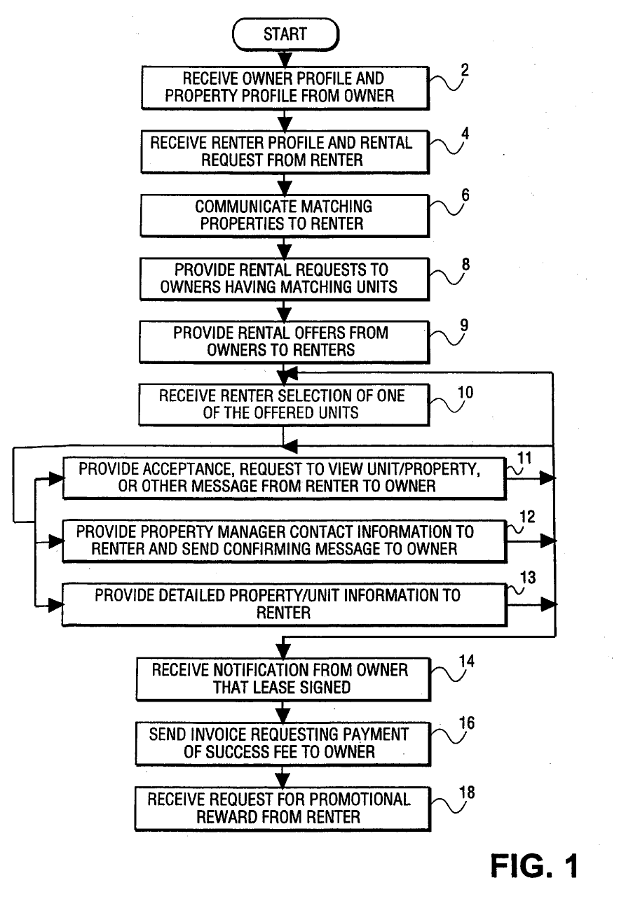

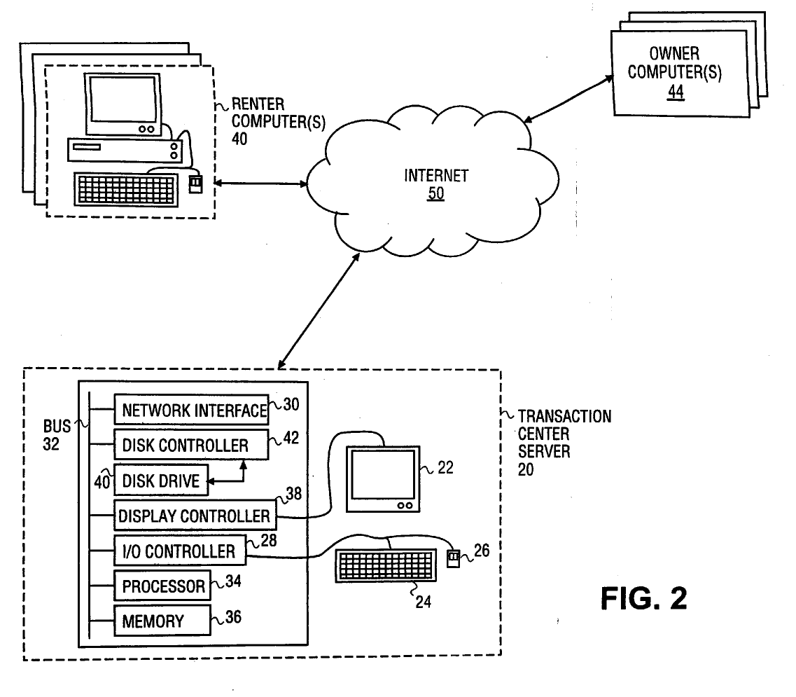

Referring now to FIG. 1, a general flow of actions of a transaction center system taken in accordance with an embodiment in which renters seek rental property from a property owner is shown. The transaction center system may be implemented as transaction center server 20 described below regarding FIG. 2. A transaction center system receives an owner profile and at least one property profile from property owners, as shown in block 2. An “owner profile” may include the name of a property owner, property management company, etc.; the name of a contact person or contact persons; a business address; a business telephone number; an email address; a facsimile number; and other identifying and contact information. A “property profile” may include information about the features of the property in general; the billing address and contact information for the property; the name of a person or persons serving as property manager or leasing agent, etc. for the particular property; the phone number and facsimile number for the particular property; and detailed information about each type of unit at the property. In one embodiment, property feature information in the property profile may include whether the property is part of a gated community and has: covered parking; a garage with direct access to units; a detached garage; assigned parking; an on site security patrol; a playground; a pool; a jacuzzi; a fitness center; tennis courts; racquetball courts; a clubhouse; a business center; a laundry facility; an elevator; storage areas; wheelchair access, etc.

Unit information may include a rent amount, rental term for the unit or home, a specification as to whether or when the particular unit or property is available, the number of bedrooms, the number of bathrooms, the size of the unit or home in square feet, and whether the unit has or does not have a plurality of features, such as, for example whether the unit is furnished; is cable-ready; has a balcony, a deck, a patio, a yard, a washer and a dryer, washer and dryer hook-ups, an intrusion alarm, air conditioning, a ceiling fan, a refrigerator, a dishwasher, a garbage disposal, a microwave oven, hardwood floors, carpeting, a fireplace, walk-in closets, vaulted ceilings, high speed Internet access, etc. It is the decision of the property owner to either enter information for only those rooms that are currently or soon to be available, or to add all rooms for the property and specify which rooms are and are not available. In one embodiment, the property owner may include floor plans and photographs of the units and/or the property with the property information and/or with the unit information.

Referring still to FIG. 1, the transaction center system receives a renter profile and rental request information from renters, as shown in block 4. The “renter profile” may include a renter's name, email address, current home address, telephone number, etc. The “rental request” may include information describing desired features and amenities of a rental unit, including: a monthly rent; either in a range or an exact amount that may be a maximum rent; a lease start date; a location such as in cross streets, town names, zip code, area code or other geographical designation; number of bedrooms; size of the unit in square feet or other measurement; and number of bathrooms. The rental request may also include more detailed information about a desired unit, such as specifying that the unit has or does not have a plurality of features, such as, for example whether the unit is furnished; is cable-ready; has a balcony, a deck, a patio, a yard, a washer and a dryer, washer and dryer hook-ups, an intrusion alarm, air conditioning, a ceiling fan, a refrigerator, a dishwasher, a garbage disposal, a microwave, hardwood floors, carpeting, a fireplace, walk-in closets, vaulted ceilings, high speed Internet access, etc.

In one embodiment, property features of the building or complex in which the unit is present may also be specified in a rental request, including whether the property is part of a gated community and has: covered parking; a garage with direct access to units; a detached garage; assigned parking; an on site security patrol; a playground; a pool; a jacuzzi; a fitness center; tennis courts; racquetball courts; a clubhouse; a business center; a laundry facility; an elevator; storage areas; wheelchair access, etc.

In one embodiment, the transaction center system may nearly instantly communicate matching properties to a renter, as shown in block 6. Providing this information to the renter may satisfy the renter that the system is taking action on the renter's behalf by displaying information about properties which may have available rooms. The transaction center system then provides rental requests to property owners having matching properties, as shown in block 8. In one embodiment, the transaction center system provides rental requests anonymously. Property owners receive rental requests that match units specified in property profiles, and decide whether to present an offer to a renter. The property owner may submit an offer to be sent to a renter via the transaction center system. Upon receipt of rental offers from property owners, the transaction center system then provides rental offers from property owners to the renter, as shown in block 9.

In one embodiment, the transaction center system provides the offers received in a table or matrix which the renter may sort by name, rent, availability, location, and other renter specified or system default headings comprised of property and/or unit features from the property information and/or the unit information. In one embodiment, the renter may also be provided the ability to select one or more of the properties such that the transaction center system will display their location on a map. In one embodiment, the transaction center system may give the user the ability to select one property about which further information may be obtained or regarding which an action may be taken, such as, for example, sending a message to the leasing agent for the property or sending an anonymous request for further information to the property manager, etc. In one embodiment, the transaction center system then receives a selection of one of the offers from the renter, as shown in block 10. The transaction center system then provides the renter the option to view detailed unit and/or property information (including photos, floor plans and the like), to send a message to the property owner, to send a request to view the property, to send a message accepting the offer to lease the property, and to obtain contact information so that the renter may contact the property owner offline, such as by telephone or going to a leasing office. In one embodiment, messages from the renter to the property owner may be delivered to the property owner anonymously, at the renter's discretion.

The transaction center system then: provides an acceptance of the lease message, a request to view the property message, or other message from the renter to the property owner as shown in block 11; provides contact information for the property's leasing agent to the renter while also sending a confirming message to the property owner, as shown in block 12; or provides the requested detailed unit/property information to the renter, as shown in block 13. When the transaction center system provides contact information to the renter regarding the property owner, the transaction center system may send a confirming message to the property owner or otherwise notify the property owner that contact information was provided to a renter so that the property's leasing agent will expect a telephone call or visit from the renter.

Assuming that the renter chooses to lease the unit selected, in one embodiment, the transaction center system may provide for the renter and property owner to negotiate and confirm a lease by sending messages back and forth via the transaction center system. In another embodiment, the renter and property owner may close a deal and enter into a lease outside of the transaction center system. In either embodiment, the property owner is required to notify the transaction center system of the execution of a lease. The transaction center system receives notification from the property owner that a lease has been signed, as shown in block 14. The transaction center system then sends an invoice requesting payment of a success or placement fee to the property owner, as shown in block 16. In one embodiment, this success or placement fee may be a pre-determined or agreed-upon percentage of the monthly rent specified in the lease, such as 20%, 30%, etc. In another embodiment, a specific agreed upon sum may be paid, such as $200, $350, etc.

In one embodiment, the renter may receive a promotional reward for using the transaction center system to enter into a lease with a property owner. In this embodiment, the transaction center system operator may send a check in the amount of the promotional reward to the renter by traditional mail after, in one embodiment, learning of the lease in block 14, or, in another embodiment, after receiving payment of a success or placement fee from the property owner. In one embodiment, the transaction center system may provide the renter the option to report entering into a lease and to request the promotional reward. In this embodiment, the transaction center system receives a request for the promotional reward from the renter, as shown in block 18. In one embodiment, the promotional reward may be a sum of money such as $25 or $100; a sum of money reflecting a percentage of the monthly rent specified in the lease such as $10%, 20%, etc.; or may be a gift such as a television or digital video disk (DVD) player. This reward serves as an incentive to have renters use the transaction center system to obtain a lease for a desirable apartment or home.

Referring now to FIG. 2, an illustrative embodiment of the network architecture of the system for facilitating renting and purchasing relationships over the internet is depicted. According to one embodiment, the system comprises a renter computer 46, a property owner computer 44, and a transaction center server 20. Herein, each of these computers is attached to the Internet 50. In one embodiment, multiple renter computers and multiple property owner computers may communicate with the transaction center server via the Internet. Renter computers and property owner computers may connect to the Internet according to methods known to those skilled in the art, including, but not limited to, telephonic connection by modem, connection by Integrated Services Digital Network (ISDN), Digital Subscriber Lines (DSL), cable television (CATV) modem, T1 line, etc. In an alternative embodiment, each of the renter and property owner computers may be connected to or may connect to the transaction center server by any means of computer communication that allows for the necessary data to be communicated between the various computers. Such connections include, but are not limited to, direct dial-up, leased lines, etc. Transaction center server 20 may connect to the Internet in a high-speed manner according to methods known to those skilled in the art, including, but not limited to, connection by ISDN, DSL, cable modem, T1 line, T3 line, etc.

In one embodiment, the method of the transaction center system is implemented as software stored in and executed by a server computer such as transaction center server 20. Transaction center server 20 may be any server computer that can execute software programs and access a communications network such as the Internet. In one embodiment, transaction center server 20 comprises processor 34 and memory 36. Processor 34 may be any computer processor, and memory 36 may be any random access memory (RAM) or other readable and writeable memory device.

Processor 34 utilizes memory 36 to execute the software that implements the method of the transaction center system. Information, including software that implements the transaction center system, is read from and written to, disk drive 40 which is coupled to disk controller 42. Disk drive 40 may be a hard disk drive, a readable and writeable compact disk (CDRW) drive, a floppy disk drive, a stick or card memory device, a digital audio tape (DAT) reader, etc., or any storage device or other machine readable medium local to the processor, as well as connected by a network or any method of communication, including, for example, wireless. The processor may communicate instructions to display controller 38 to display images on display device 22. Display controller 38 may be any display controller, and display device 22 may be any display monitor, including, but not limited to, a cathode ray tube (CRT) display monitor, or thin film transistor (TFT) display screen. A system administrator or other similar person may access transaction center server 20 via any computer input device, such as, for example, keyboard 24 and mouse 26 which are coupled to the processor by I/O controller 28.

Transaction center server 20 also includes network interface 30. In this embodiment, transaction center server 20 communicates with a network, a wide area network, or, in one embodiment, the Internet 50. Network interface 30 may be a digital modem, a cable modem, an Ethernet card, or any other kind of network access device that allows for connection to the Internet via DSL, cable television line, T1 line, T3 line, or any other high speed, dedicated line capable of communicating information over a network. Processor 34, memory 36, disk controller 42, display controller 38, I/O controller 28, and network interface 30, are coupled to one another, via and communicate with one another over bus 32. Bus 32 may be any bus that provides for communication of and between components within a computer. Although only one bus is depicted, multiple buses may be used in transaction center server 20. In addition, other components and controllers (not depicted) or multiple instances of depicted components and controllers may be included in transaction center server 20.

In one embodiment, each of transaction center server 20, property owner computer 44, and renter computer 46 include software that allows for communication over the world wide web via Internet 50. In one embodiment, this includes software that provides for communication via the hyper-text transfer protocol (HTTP) and the transmission connect protocol/internet protocol (TCP/IP), and/or other network communication protocols. In one embodiment, to access transaction center server 20, renter computer 46 and property owner computer 44 run web browsing software, such as, for example Netscape Communicator® available from Netscape Communications Corporation of Mountain View, Calif.

Although only one transaction center server 20 is depicted, a system that implements the method of the present invention may be comprised of multiple computers in the form or a local area network (LAN), cluster, grouping, subnetwork, etc. (not shown). In this embodiment, the transaction center system may include routers, gateways, switches, and other computer communications equipment (not shown). The transaction center system in the form of a grouping, cluster, LAN, subnetwork, etc. may be connected to the Internet or other global communications network, in one embodiment, via one or more firewalls or other security devices and systems so that the server is separated from the Internet and other computers for security purposes. In this embodiment, the transaction center system may be comprised of graphics servers, application servers, web servers, database servers, email servers, and other specialized, dedicated servers (not shown).

In one embodiment, the transaction center system may include database software that supports, or a database server running database software that supports, Java® Database Connectivity (JDBC) application programming interfaces, Open Database Connectivity (ODBC) application programming interfaces as well as the structured query language (SQL) or any other database languages. In one embodiment, the transaction center system may include email software that allows the system to send email to and receive email from renters and property owners over the Internet. In one embodiment, the transaction center system may include messaging software that supports email-like communications between renters and property owners. In this embodiment, the renters and property owners may send and receive email-like messages from web pages provided to the renter and property owner after logging on to the transaction center system. The messaging software may provide support for renters to send anonymous email-like messages to property owners through the transaction center system.

In one embodiment, the transaction center system may include data transfer software that provides support for the uploading of graphical images in various formats which may be displayed to enhance the renter's viewing of property and/or unit information by allowing for display of unit and/or property photographs and/or floor plans. In this embodiment, the transaction center system may also include software that allows for the display of graphical images in various formats to the renter and property owner via a web browser at the renter's computer or the property owner's computer. Graphical images may be in any format, including, but not limited to, two-dimensional formats such as graphics interchange format (GIF), joint photographic experts group (JPEG) format, and bitmap (BMP) formats, and 360 degree formats such as QuickTime VR (QTVR) and Interactive Pictures Corporation (IPIX) formats. In these embodiments, a graphics server, transfer server or other specialized server may include software to provide these capabilities and features.

Renter computer 46 and property owner computer 44 may be personal computers having components and features similar to transaction center system server 20. In addition, renter computer 46 and property owner computer 44 may be any personal computing device that can execute programs and access a network such as the Internet, including, but not limited to, cellular telephones, personal digital assistants, computer tablets, desktop personal computers, portable computers, Internet appliances, computer workstations, etc.

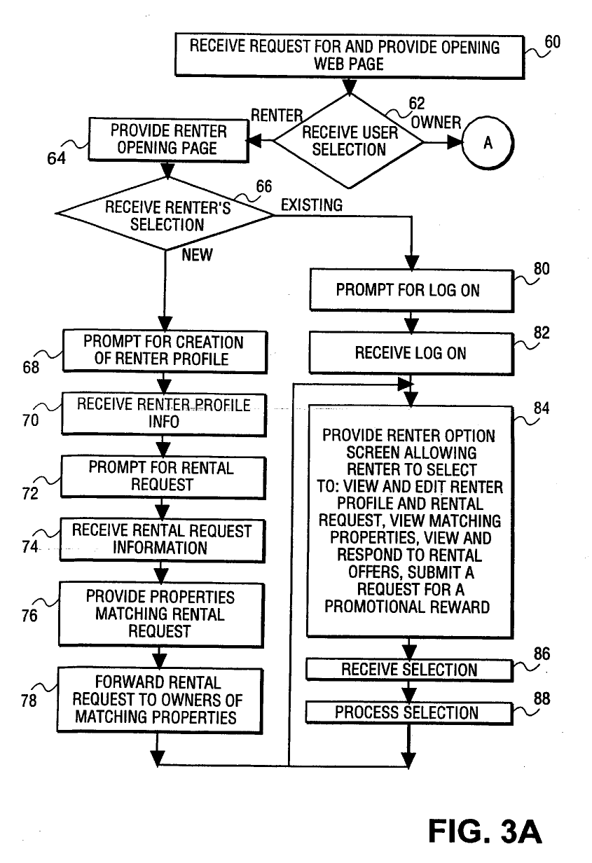

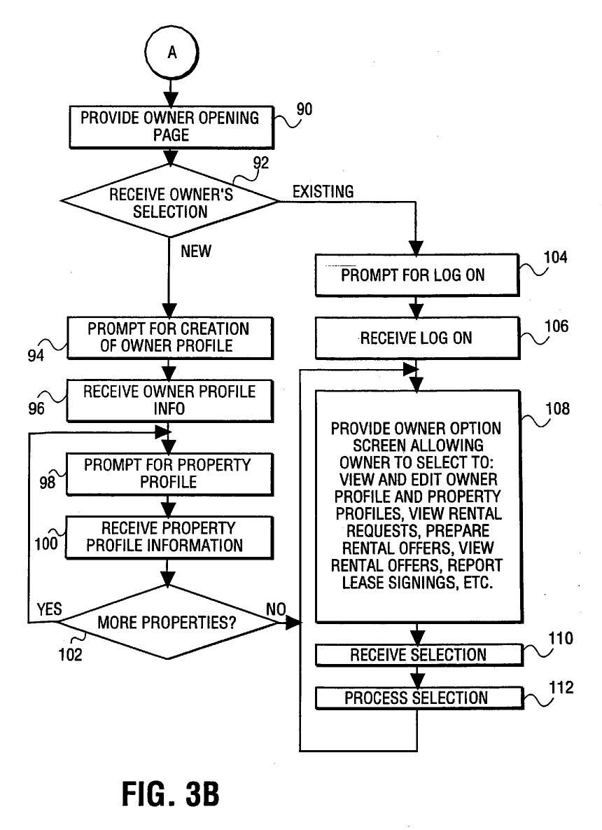

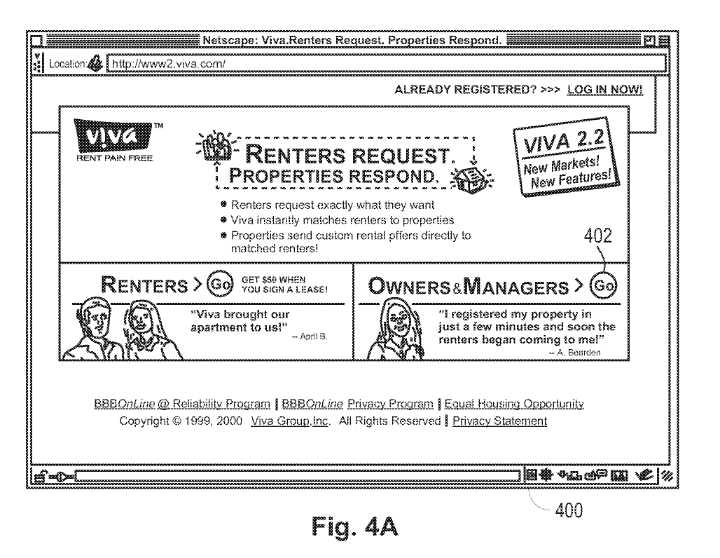

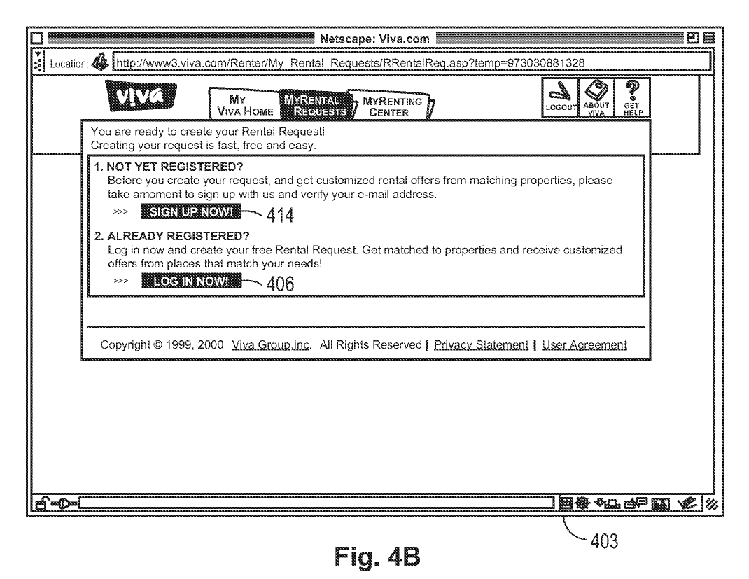

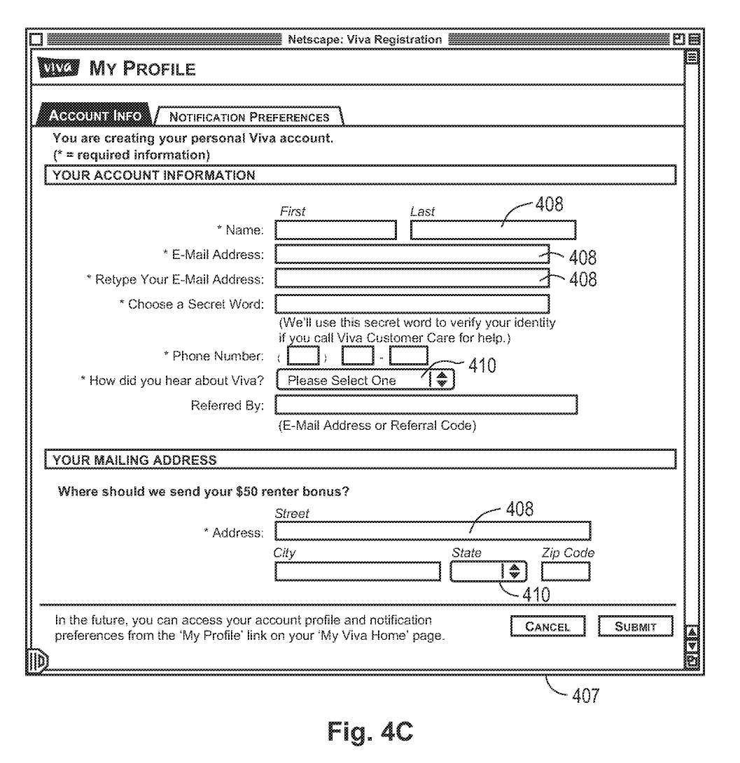

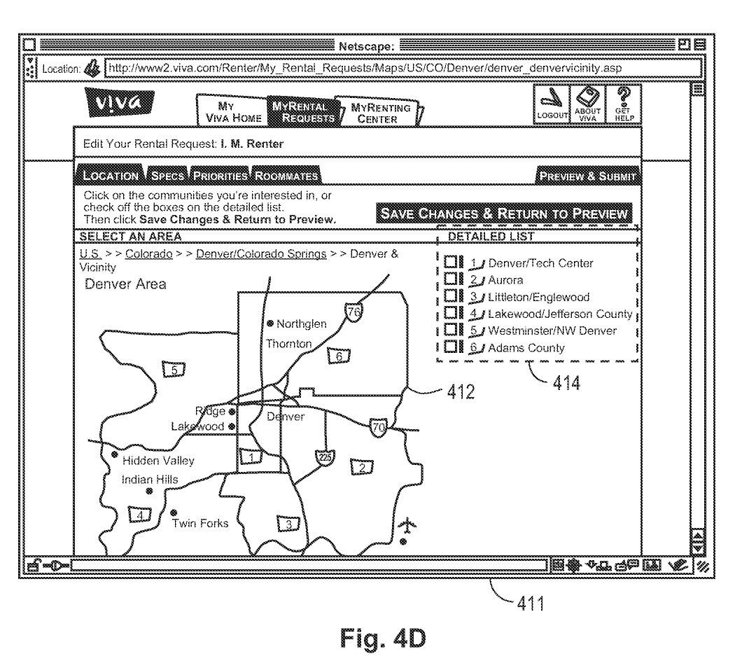

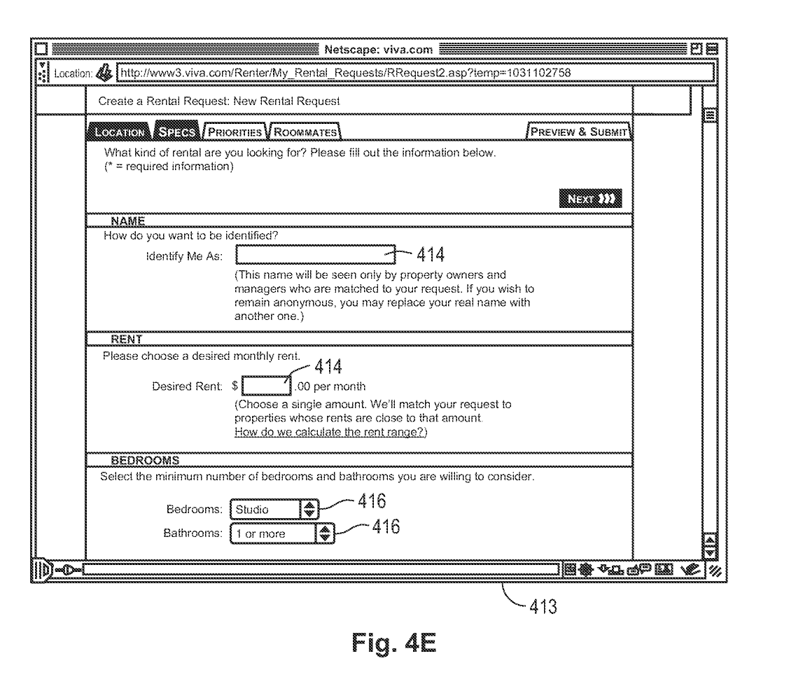

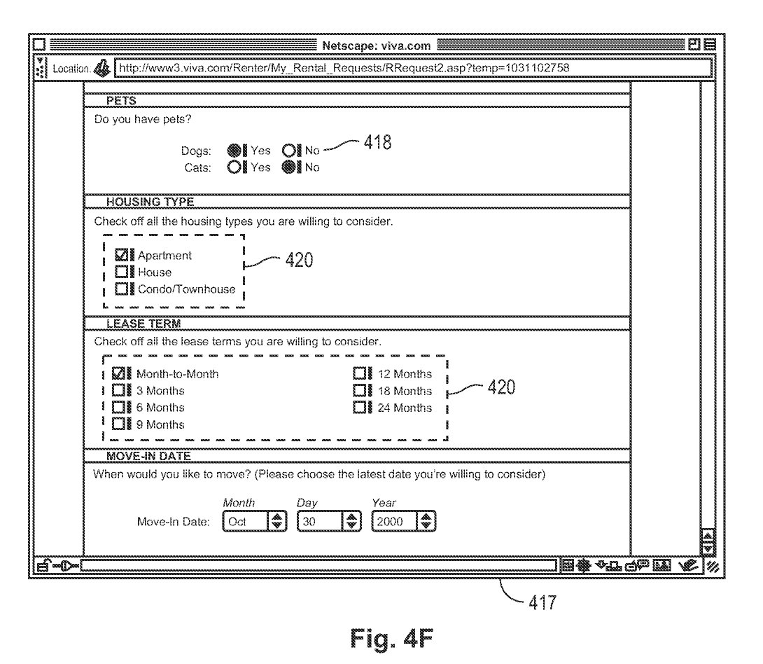

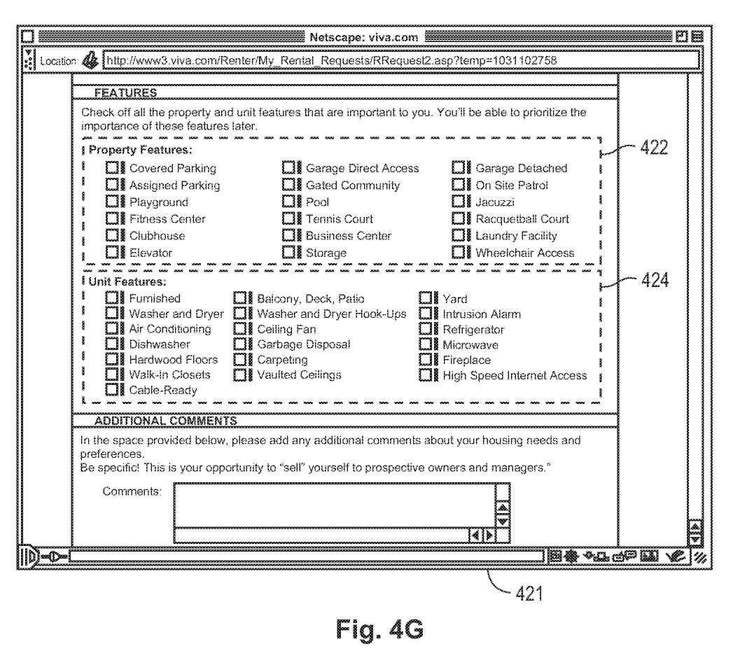

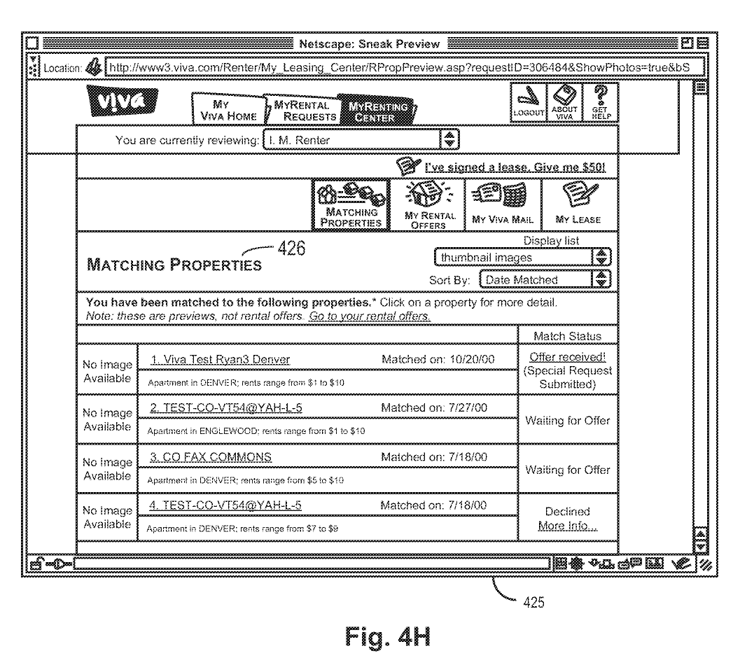

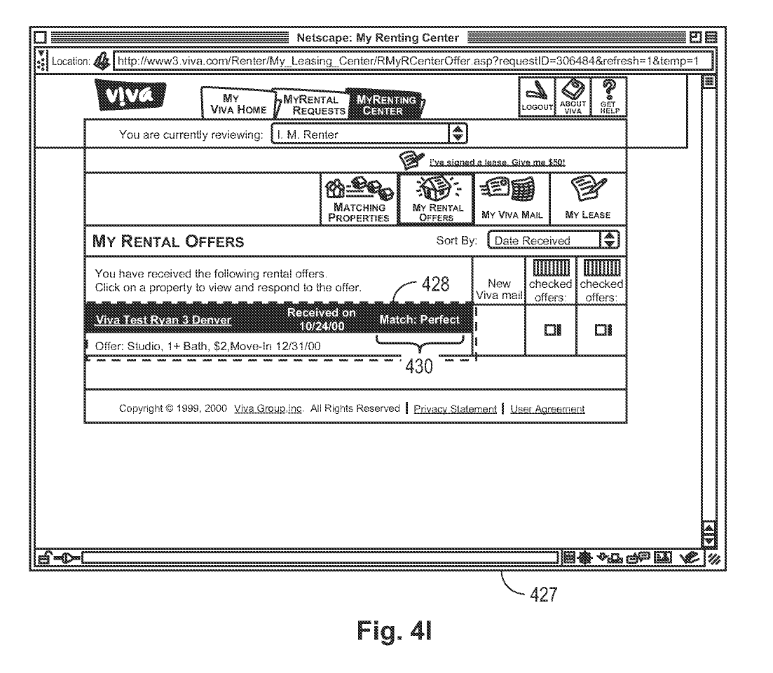

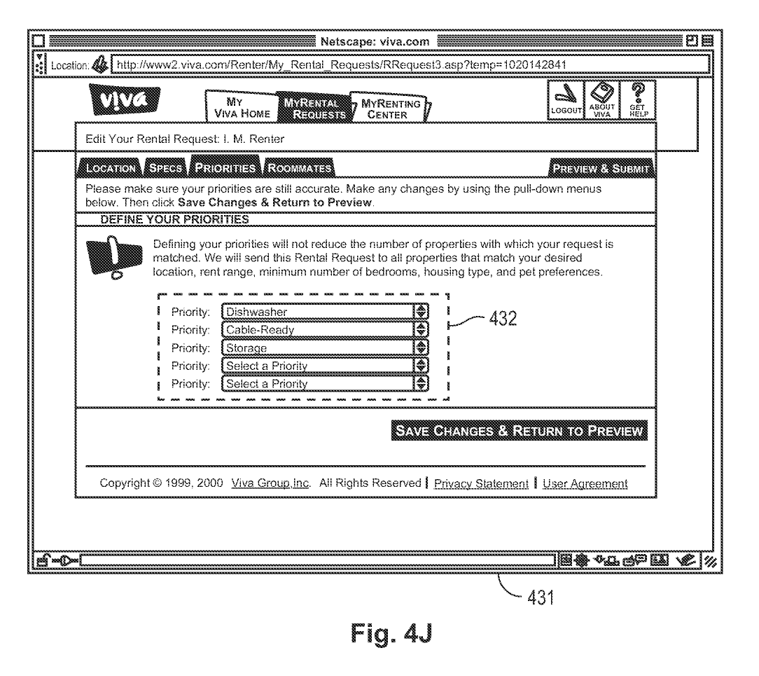

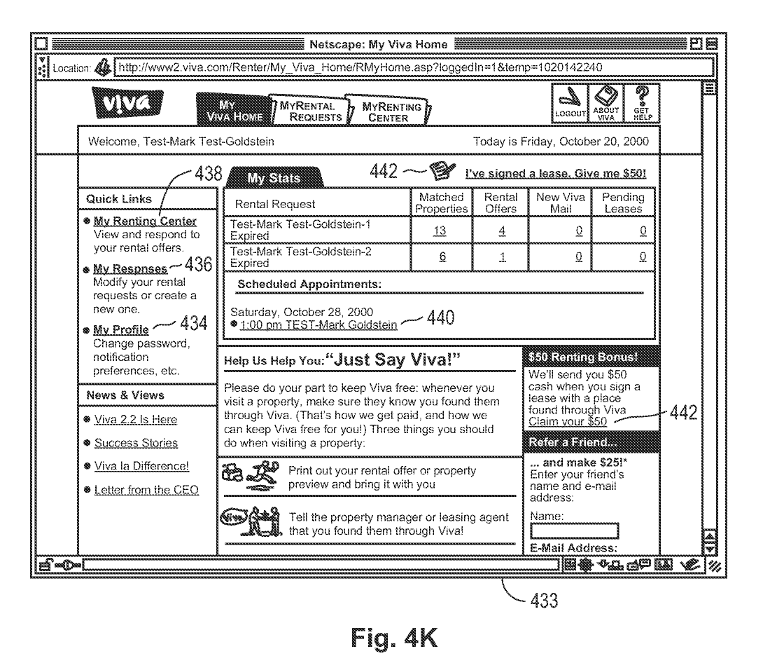

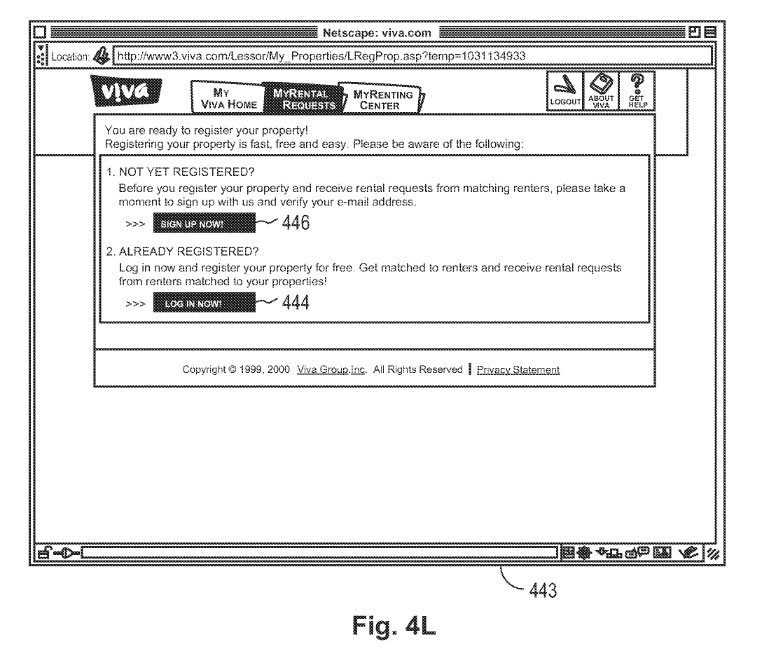

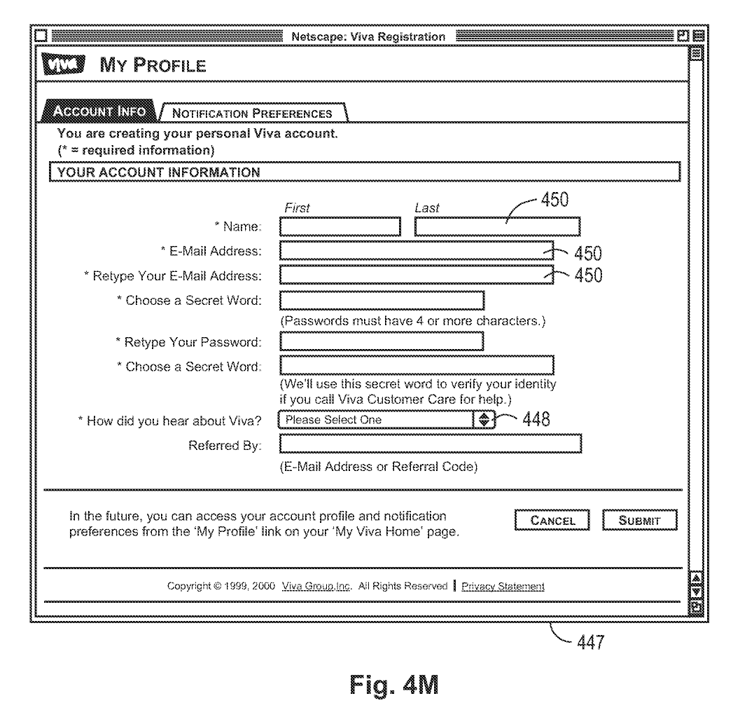

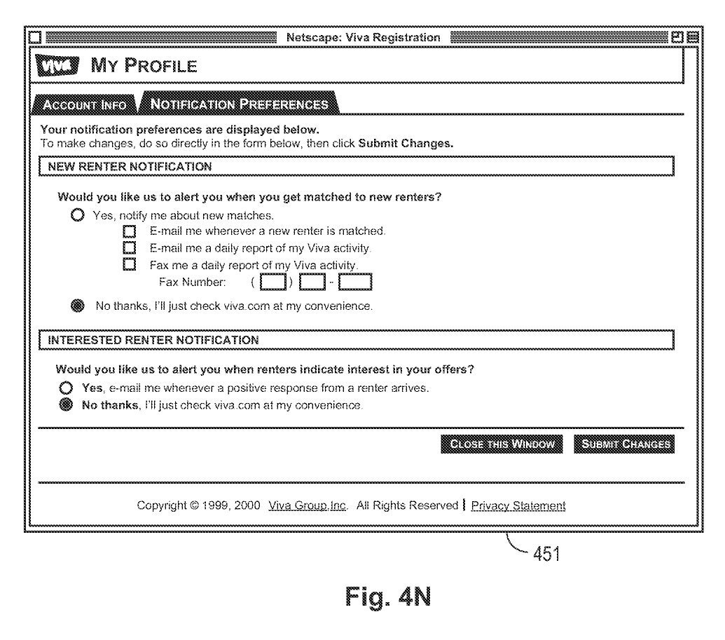

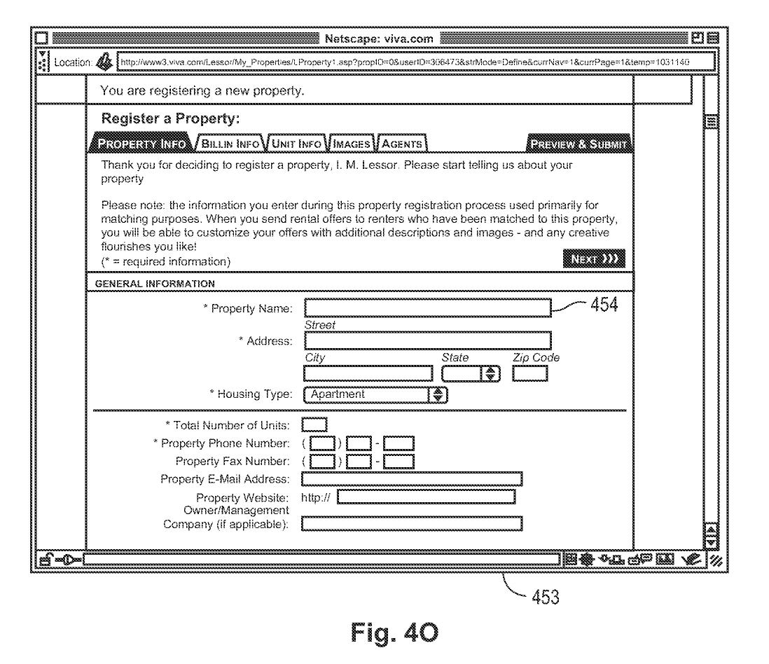

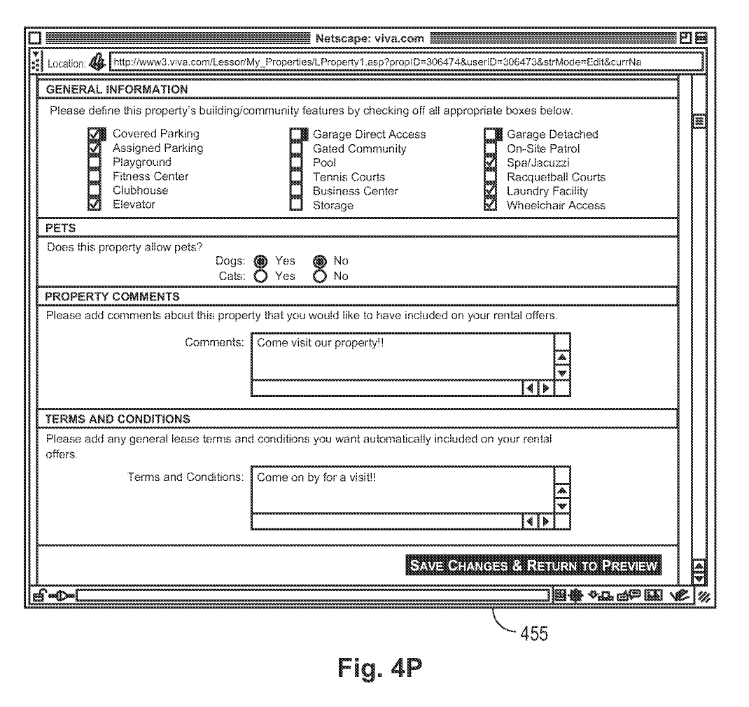

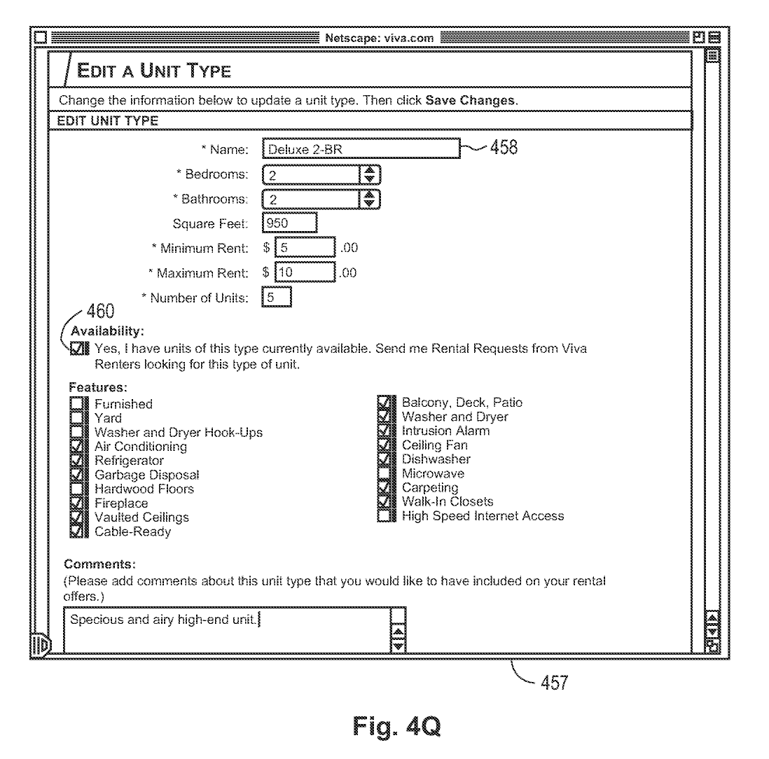

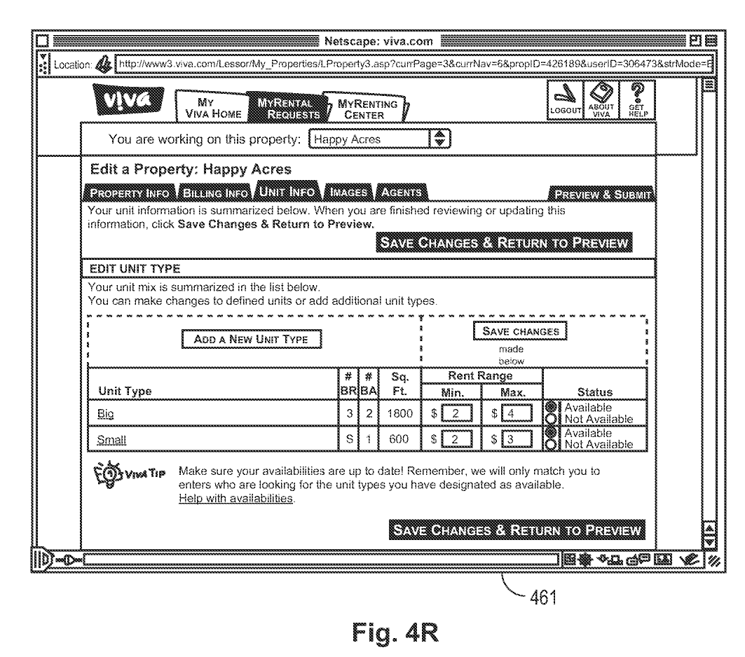

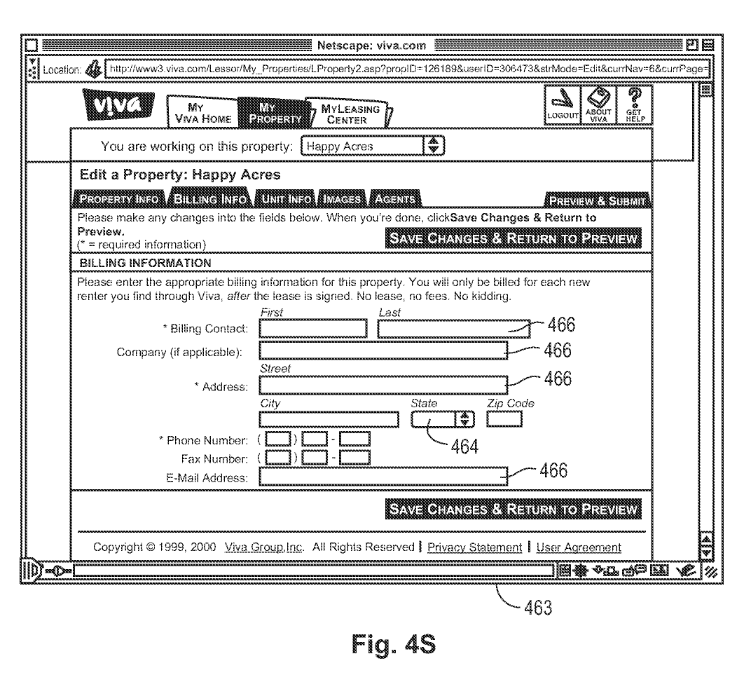

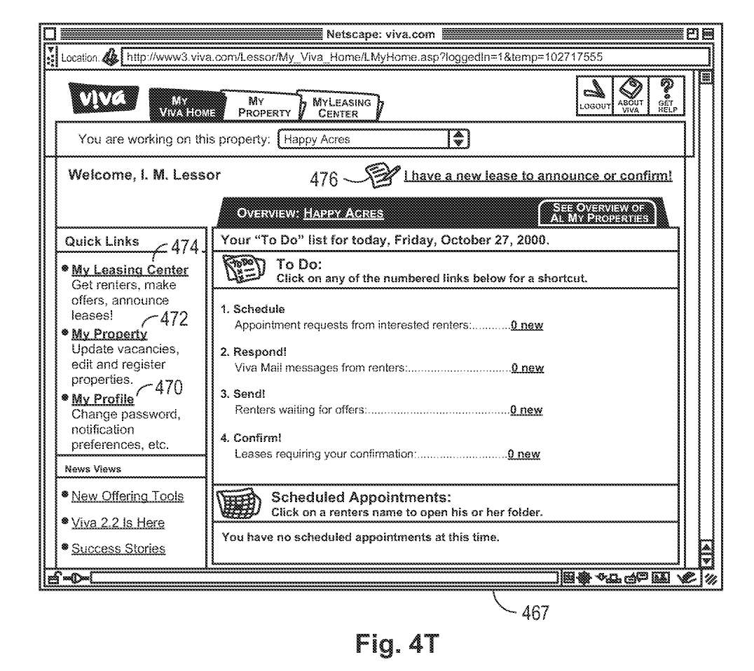

FIG. 3 illustrates a more detailed flow of actions of a transaction center server taken according to an embodiment of the system and method of the present invention while FIGS. 4A-4T illustrate various example web pages utilized for this embodiment. The transaction center system of the present invention may be implemented in software and may be executed on a computer known as a server or multiple servers as described above. When an Internet user chooses to access the features of the transaction center system, the user may request the web page of the transaction center system via an Internet web browser on the renter computer or the property owner computer. Upon receiving the request, the transaction center system will then provide an opening web page to the user, as shown in block 60. An example opening web page is illustrated in FIG. 4A.

The opening web page 400 prompts the user to select whether the user is a renter or a property owner. Web page 400, and the other web pages and mentions of prompting herein, may include graphics, text, text entry fields, tables, frames, menu lists, icons, sliders, pull-down menus, and other user interface items. The web pages may be provided in hyper-text markup language (HTML) with JAVA® applets and other web-based software embedded or referenced therein. In one embodiment, the user may make a selection of information or activate buttons such as “go” button 402 using a mouse click or other input device, and may enter text via a keyboard or other input device.

Referring back to FIG. 3, the transaction center system then receives the user's selection, as shown in block 62. If the user selects renter, the transaction center system provides the user a renter opening web page, as shown in block 64. An example renter opening web page is illustrated in FIG. 4B. The renter opening web page 403 prompts the renter to select whether the renter is a new renter who wants to create a renter profile by activating button 404, or is an existing renter who wants to log on by activating button 406. The transaction center system receives the renter's selection, as shown in block 66. If the renter selects new renter, the transaction center system prompts the renter to create a renter profile, as shown in block 68. This prompting is achieved by the transaction center system providing a web page or sequence of web pages that prompts the user to enter information to create a renter profile. An example web page 407 that prompts the renter to enter renter profile information via text entry areas 408 and menus 410 is illustrated in FIG. 4C. The transaction center system may then receive renter profile information, as shown in block 70. After creating a renter account by creating a renter profile, the transaction center system prompts the renter to create a rental request, as shown in block 72.

As part of prompting the renter to provide rental request information, the transaction center system may, in one embodiment, provide the renter a sequence of maps from which the renter may select one or more desired property locations. For example, the transaction center system may provide the renter a map of the United States from which the renter may select a state by clicking on the desired state. The transaction center system may then provide the renter a map of the selected state with regions of the state serviced by the system presented in various different colors and labeled by a commonly known geographical designator from which the renter may select a region by clicking on the desired region. In one embodiment, the transaction center system may then provide a regional map to the renter with cities, towns and neighborhoods serviced by the system presented in various different colors and labeled by a commonly known name. In this embodiment, the regional map may include a checklist of cities, towns and neighborhoods from which a renter may select one or more to designate the desired property location. An example web page 411 providing the renter a regional map 412, including a checklist 414, is illustrated in FIG. 4D.

An example web page that prompts the renter to enter rental request information is illustrated in FIGS. 4E, 4F and 4G. The web page takes up more than a full printed page and is broken up in to three parts represented by 413, 417, and 421. The rental request may include both desired property features 422 and desired unit features 424. In one embodiment, the transaction center system may allow the renter to enter two or more rental requests. In this embodiment, the rental requests may be named by the renter for easy identification. Prompting the user to enter a rental request may include providing text fields 414, menus 416, boolean selectors 418, check-off boxes 420, and other user-interface items and techniques. The renter initiates a search for matching units by submitting the rental request, such as by, in one example, clicking on a user interface provided button or hot spot.

The transaction center system then receives rental request information from the renter, as shown in block 74. In one embodiment, the transaction center system may prepare and send to the renter's email address a renter profile confirmation email message which may include a summary of the renter profile information and/or a rental request email confirmation message which may include a summary of the rental request.

After the renter submits a rental request, a matching engine processes the rental request, and the transaction center server provides the renter with a list of properties matching the rental request, as shown in block 76. An example web page 425 providing a list of matching properties 426 to a renter is illustrated in FIG. 4H. The transaction center system also forwards the rental request to property owners of matching properties, as shown in block 78. In one embodiment, matching is achieved via a matching engine incorporated with the transaction center software. In one embodiment, the matching engine selects only those properties that have units that meet certain threshold criteria. The transaction center system provides the rental offers to the property owners of properties having units that the matching engine determines match the threshold criteria. In one embodiment, the threshold criteria include whether the unit has a monthly rent within a renter specified rent range, whether the unit is near the location specified by the renter, whether the unit is the specified type of unit, and whether the unit has a minimum number of bedrooms specified by the renter. In other embodiments, the threshold criteria include units with rents below a renter specified maximum, units that match pets allowed, units that exactly match a renter specified number of bedrooms, and units that match a renter specified number of bathrooms. These criteria are referred to as threshold criteria because rental requests are only provided to property owners with units that meet all of the threshold criteria so that units not meeting all of the threshold criteria are not presented to the renter. In one embodiment, the threshold criteria are pre-selected by the transaction center system and are not modifiable.

In one embodiment, the list of properties presented to the user may be accompanied by a matching engine ranking which reflects how close supplemental criteria match the rental request. Supplemental criteria are all those criteria not included in the threshold criteria. The ranking may also take into consideration how closely the threshold criteria match the rental request. For example, a three or five star system may be used; a good, better, best system may be used; and any other way of ranking or classifying how close the supplemental criteria and/or threshold criteria of a unit match the features specified in the rental request. Similarly, when the renter views rental offers received from property owners of matching properties, the transaction center system may provide a ranking accompanying each rental offer received based on the supplemental criteria and/or the threshold criteria. An example web page 427 providing a list of rental offers 428 to a renter, including a ranking, is illustrated in FIG. 41. In this example, the ranking 430 of the rental offer 428 is “perfect.”

In one embodiment, the transaction center system may also allow the renter to select certain criteria as priority criteria, such that supplemental criteria selected as priority criteria will car more weight in the matching process and/or the ranking process. An example web page 431 allowing the renter to select priorities 432 is illustrated in FIG. 4J. In another embodiment, the renter may be allowed to classify each of the supplemental criteria according to a degree of importance, one star to five stars, from “don't care” to “must have,” etc. with other gradations in between the two extremes. Other similar classification methods may be provided. The priority criteria and/or the classifications may be used by the matching engine to rank the units or properties which are presented to the renter when viewing rental offers received from property owners. In one embodiment, the transaction center system may provide the renter the ability to filter property owner offers based on the priority criteria and/or classifications such that offers made by property owners which do not meet or exceed the priority criteria and/or the classifications are not displayed to the renter. In this embodiment, the renter may set this feature on or off before, after or during receipt of and viewing of rental offers.

After forwarding the rental request to matching property owners (that is, property owners matching the threshold criteria), the transaction center system provides a renter option screen to the renter which allows the renter to select whether the renter wishes to view and/or edit the renter profile 434 and rental requests 436, view matching properties, view and respond to rental offers 438, submit a request for a promotional reward 442, etc., as shown in block 84. An example renter option web page 433 is illustrated in FIG. 4K. In various embodiments, the renter may also be provided the option to request an appointment to view and/or inspect a property, view pending appointments to view and/or inspect properties 440, and perform other tasks and view other information. The transaction center system receives the renter's selection, as shown in block 86, and processes the selection as shown in block 88. Processing includes providing the necessary web pages to accomplish the selection requested by the renter.

If after the transaction center system provides the renter opening page the renter selects that the renter is an existing renter, the transaction center system receives the renter's selection, as shown in block 66, and the transaction center system then prompts the renter to log on to the transaction center system, as shown in block 80. This log on may be achieved by requesting a user name, an email address, or any other renter identifier. In one embodiment, the renter must also provide a password. In other embodiments other forms of renter authentication may be used, such as, for example, voice recognition, fingerprint scan, retinal scan, etc. The transaction center system receives the renter log on, as shown in block 82. Flow then continues at block 84 as discussed above. That is, a renter option screen is provided to the renter such as the example renter option web page 433 illustrated in FIG. 4K.

Upon being provided an opening web page by the transaction center system, as shown in block 60, the user may select property owner. The transaction center system receives the user selection, as shown in block 62, and provides a property owner opening page, as shown in block 90. An example property owner opening web page 443 is illustrated in FIG. 4L. The property owner opening web page prompts the property owner to select whether the property owner is a new user who wants to create a owner profile by activating button 446, or is an existing user who wants to logon by activating button 444. The transaction center system receives the property owner's selection, as shown in block 93. If the property owner selects new property owner, the transaction center system prompts the property owner to create an owner profile, as shown in block 94. This prompting is achieved by the transaction center system providing a web page or sequence of web pages that prompts the property owner to enter information to create an owner profile. An example web page 447 prompting the property owner to enter owner profile information via text fields 450 and menu 448 is illustrated in FIG. 4M. The transaction center system may then receive the owner profile information, as shown in block 96. According to one embodiment, for a property owner to use the transaction center system, the property owner must provide a mailing address to which an invoice will be mailed to request payment of a success fee or commission from the property owner. In one embodiment, when prompting the property owner to provide the owner profile information, the transaction center system may provide the property owner the option to be notified by methods outside of the transaction center system when certain events occur, such as, when matching rental requests are found, when renter messages are received, etc. The option may be provided to notify the property owner by fax, email, etc. An example notification option web page 451 is illustrated in FIG. 4N.

After the owner profile has been received, the transaction center system prompts the property owner for a property profile, as shown in block 98. Example web pages 453 and 455 prompting the property owner to enter property profile information are illustrated in FIGS. 4O and 4P. The transaction center system may then receive property profile information, as shown in block 100. For each property owner, multiple property profiles may be entered. In one embodiment, the transaction center system allows the property owner to provide a name for each property profile so that each property profile is readily identifiable. This may be achieved via text entry field 454. These property profile names may be the street address of a building, a name of a building or development, or any other identifier.

In one embodiment, prompting for and receiving property profile information includes prompting for and receiving unit information for each kind of unit in each property. Example web pages 457 and 461 prompting the property owner to enter unit information, including whether the unit is available, are illustrated in FIGS. 4Q and R. In another embodiment, prompting for and receiving profile information includes prompting for and receiving unit information for each unit in each property. In one embodiment, all units must be specified, whether they are available or not. In another embodiment, only those units or kinds of units that are currently available may be specified. In one embodiment, the transaction center system allows the property owner to provide a name or other identifier for each unit or kind of unit specified such as by text entry field 458. Availability may be specified, in one embodiment, via check-off box 460. At least one unit or one unit type must be entered for each apartment or condominium building.

In one embodiment, the transaction center system may provide the property owner the option to set up an automated offer feature for a rental unit. In this embodiment, after receiving all other unit information, the transaction center system may prompt the property owner specify whether an automated offer should be sent in response to receiving a rental request. If the property owner opts in to the automated offer feature, the transaction center system prompts the user for automated offer details such as monthly rent, kind of lease, etc.

According to one embodiment, for a property owner to use the transaction center system, the property owner must provide billing information, including an address to which an invoice will be mailed to request payment of a success fee or commission from the property owner. In one embodiment, prompting for and receiving property profile information includes prompting for and receiving billing information. An example web page 463 prompting the property owner to provide billing information via text entry fields 466 and menu 464 is illustrated in FIG. 4S. In this embodiment, each property may have different billing information associated with it.

After property profile information is received, the transaction center system checks to determine whether the property owner wants to enter more property profiles, as shown in block 102. If the property owner selects that the property owner wants to enter more property profiles, the flow continues at block 98.

After the owner profile and property profiles have been received, the transaction center system provides the property owner a property owner option screen which allows the property owner to select whether the property owner wishes to view and edit the owner profile 470 and property profiles 472, view rental requests 474, prepare rental offers 474, view rental offers 474, report lease signings 476, etc., as shown in block 108. An example property owner option web page 467 is illustrated in FIG. 4T. The transaction center system receives the property owner's selection, as shown in block 110, and processes the selection as shown in block 112. This processing includes providing the necessary web pages to accomplish the selection requested by the property owner. In one embodiment, the transaction center system allows the property owner to select multiple rental requests and provide the same rental offer to each of the renters associated with the selected rental requests.

If after the transaction center system provides the property owner opening page the user selects that the user is an existing user, the transaction center system prompts the user to log on to the transaction center system, as shown in block 104. The transaction center system receives the property owner log on, as shown in block 106. The transaction center system then provides the property owner option screen, as shown in block 108, as discussed above. An example property owner option web page 467 is shown in FIG. 4T.

In one embodiment, the transaction center system may store information about leases consummated such that a pre-defined time before the end of the lease, the transaction center system may notify the property owner that a particular unit will soon be available or require a new lease to be signed. The transaction center system may provide this lease end notification by email, by internal transaction center system message, or by any other method. In various embodiments, the lease end notification may be provided automatically to all participating property owners, or may only be provided to those property owners who opt in to this feature during, for example, creation of a property profile or an owner profile.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A computer-implemented method comprising:
receiving a property profile from a responsible party responsible for disposition of a property corresponding to the property profile;
receiving a selection from a requester party, the selection being of a portion of a map representative of a geographical region that includes the property corresponding to the property profile, the receiving of the selection being performed by a transaction center server computer using a network interface of the transaction center server computer;
receiving a transaction request from the requester party, the transaction request including property information regarding a property aspect;
matching the transaction request to the property profile based on the portion of the map and the property information regarding the property aspect, the matching being performed by the transaction center server computer executing software; and
communicating the property profile to the requester party.

2. The computer-implemented method of claim 1 further comprising:
receiving availability data of the property, the availability data indicating whether the property is available; wherein
the communicating of the property profile to the requester party includes communicating the availability data.

3. The computer-implemented method of claim 2, wherein
the availability data indicates when the property will become available.

4. The computer-implemented method of claim 1 further comprising:
presenting the requester party with the map representative of the geographical region that includes the property corresponding to the property profile.

5. The computer-implemented method of claim 4 further comprising:
presenting the requester party with a sequence of maps, the sequence of maps including the map representative of the geographical region that includes the property corresponding to the property profile.

6. The computer-implemented method of claim 1, wherein
the map includes a geographical designator corresponding to the geographical region that includes the property corresponding to the property profile.

7. The computer-implemented method of claim 1 further comprising:
prompting the requester party to select the portion of the map from a plurality of portions of the map.

8. The computer-implemented method of claim 1, wherein
the portion of the map is representative of at least one of a state, a city, a town, or a neighborhood.

9. The computer-implemented method of claim 1, wherein
the transaction request includes a name to identify the transaction request, the name being generated by the requester party.

10. The computer-implemented method of claim 1 further comprising:
defining a time prior to the end of a lease of the property corresponding to the property profile; and
notifying the responsible party at the defined time that the lease will end.

11. A computer comprising:
a network interface;
a processor communicatively coupled to the network interface; and
a memory communicatively coupled to the processor and to the network interface, the memory to store software that, when executed by the processor, causes the computer to:
receive a property profile from a responsible party responsible for disposition of a property corresponding to the property profile;
receive a selection from a requester party via the network interface, the selection being of a portion of a map representative of a geographical region that includes the property corresponding to the property profile;
receive a transaction request from the requester party via the network interface, the transaction request including property information regarding a property aspect;
match the transaction request to the property profile based on the portion of the map and the property information regarding the property aspect; and
communicate the property profile to the requester party.

12. The computer of claim 11, wherein the software, when executed by the processor, causes the computer to:
receive availability data of the property, the availability data indicating whether the property is available; wherein
the communicating of the property profile to the requester party includes communicating the availability data.

13. The computer of claim 12, wherein
the availability data indicates when the property will become available.

14. The computer of claim 11, wherein the software, when executed by the processor, causes the computer to:
present the requester party with the map representative of the geographical region that includes the property corresponding to the property profile.

15. The computer of claim 14, wherein the software, when executed by the processor, causes the computer to:
present the requester party with a sequence of maps, the sequence of maps including the map representative of the geographical region that includes the property corresponding to the property profile.

16. The computer of claim 11, wherein
the map includes a geographical designator corresponding to the geographical region that includes the property corresponding to the property profile.

17. The computer of claim 11, wherein the software, when executed by the processor, causes the computer to:
prompt the requester party to select the portion of the map from a plurality of portions of the map.

18. The computer of claim 11, wherein
the portion of the map is representative of at least one of a state, a city, a town, or a neighborhood.

19. The computer of claim 11, wherein
the transaction request includes a name of the transaction request, the name generated by the requester party.

20. The computer of claim 11, wherein the software, when executed by the processor, causes the computer to:
define a time prior to the end of a lease, the lease being of the property corresponding to the property profile; and
notify the responsible party at the defined time that the lease will end.

21. A machine-readable storage medium comprising a set of instructions that, when executed by one or more processors of a machine, cause the machine to:
receive a property profile from a responsible party responsible for disposition of a property corresponding to the property profile;
receive a selection from a requester party, the selection being of a portion of a map representative of a geographical region that includes the property corresponding to the property profile;
receive a transaction request from the requester party, the transaction request including property information regarding a property aspect;
match the transaction request to the property profile based on the portion of the map and the property information regarding the property aspect; and
communicate the property profile to the requester party.
